(19) United States
(12) Patent Application Publication
(10) Pub. No.: US 2010/0148078 A1
(43) Pub. Date: Jun. 17, 2010

(54) X-Ray Image Detector

(75) Inventors: Yury A. Veip, St. Petersburg (RU); Alexey A. Borisov, Sosnovy Bor (RU); Valery V. Kozodoi, Kirovski district (RU); Voldemar O. Reboni, St. Petersburg (RU)

Correspondence Address: HOUSTON ELISEEVA, 4 MILITIA DRIVE, SUITE 4, LEXINGTON, MA, 02421, US

(73) Assignee: ZAO "IMPULSE", St. Petersburg (RU)

(21) Appl. No.: 12/332,639

(22) Filed: Dec. 11, 2008

(51) Int. Cl. G01T 1/20

(52) U.S. Cl. 250/368

(57) ABSTRACT

The present invention refers to X-ray technology and is intended for application in medical X-ray units. A small-sized X-ray image detector is created, wherein the photoelectric sensor is protected against X-rays, but the capability of obtaining high-quality images is retained. The X-ray image detector incorporates a housing 1 with a wall 2 radiotransparent, in which a fluorescent screen 3, an optical system 4 and a CCD matrix 5 are installed; protective screen functions are provided by the lenses incorporated in the optical system, at least ten of which shall have refraction index no less than 1.6, and the fluorescent screen attenuates X-rays by 30%.

### FIELD OF THE INVENTION

The present invention pertains to X-ray technology and is intended for application in medical X-ray units.

### BACKGROUND OF THE INVENTION

The X-ray image detector belongs to the class of the apparatus where the primary X-ray image is transformed by the fluorescent screen into the visible one, which is then recorded by the photoelectric image sensor (X-ray technology. Ed. by V. V. Kljuev, Vol. 2.—M.: Engineering, 1980, pp. 246-247).

In this class there are several modifications of the X-ray image detectors differing from one another in their signal processing potentialities, modes of operation, overall dimensions, etc. However, all the detectors of this class are characterized by the problem associated with filtering the X-rays passing through the fluorescent screen and falling on the photoelectric sensor, which cause its destruction within some time of operation. To prevent X-rays from falling on the photoelectric sensor, the X-ray image detectors are provided with the X-ray protection systems, which either employ the X-ray absorbing filters, or practice the method of keeping the photoelectric sensor outside the X-ray beam zone by means of geometrical separation of visible rays and X-rays.

The X-ray image detector is known (X-ray technology. Ed. by V. V. Kljuev, Vol. 2.—M.: Engineering, 1980, p. 246), which is placed inside a light-protective hood, incorporating the fluorescent screen operating in transmission mode, the optical system transferring the image from the screen to the image sensor, the system to protect the sensor against X-rays, and the photoelectric sensor. Protection is provided by means of the mirror placed at the angle of 45° to the direction of light beams, which is transparent to X-rays and divert over 90° the direction of visible rays, which further arrive at the photoelectric sensor.

The main disadvantages of this apparatus are its large overall dimensions and an appreciable loss of the X-ray image detector efficiency because of the limited angular aperture of the image transfer system.

Another X-ray image detector is known (U.S. Pat. No. 6,002,743), in which a radiopaque solid lead glass plate intended to absorb the residual X-rays is installed between the fluorescent screen and the optical system. The thicker is the plate, the better it protects the photoelectric sensor. Accordingly, the entire X-ray image detector reliability is considerably enhanced. However, application of the radiopaque glass brings about an unwanted by-effect, i.e. intensification of the parasitic luminous fluxes between the fluorescent screen and the optical system, and, consequently, heavy distortions of luminous fluxes in the optical channel leading to a heavily distorted X-ray image being visualized.

This is explained as follows. Brightness of the X-ray flux portion that has passed through the patient is not uniform itself and also differs dramatically from the other portion of X-ray flux. Consequently, brightness of various parts of the visible image obtained on the fluorescent screen is not the same. The brightest parts generate strong Lamberth's incandescence within wide solid angles. The respective luminous fluxes freely propagate in the lead glass plate in random directions, and only some fractions of them enter the optical channel. Other fractions of these luminous fluxes, being multiply reflected from the detector components and propagating within the lead glass plate or passing through it, may enter the optical channel, generate a random set of optical interference, and reach the relatively dark screen zones, creating a random flare comparable with the brightness of these zones. This unwanted effect is particularly manifested in the case when the angle of incidence of the light rays falling from the fluorescent screen on the optical system lens surface is greater than the total internal reflection in the lead glass. Moreover, the secondary reflection leads to light polarization.

Overall dimensions of this X-ray image detector are smaller than those of the detector with geometrical separation of the optical rays and X-rays, but image quality is not high.

The X-ray image detector which is the closest to the proposed one in its essential features is the detector incorporating a light-tight housing one wall of which is radiotransparent, wherein there are a fluorescent screen, an optical system and a photoelectric memory installed in series (X-ray technology. Ed. by V. V. Kljuev, Vol. 2.—M.: Engineering, 1980, pp. 246-247).

The drawback of the known apparatus is its large size associated with the geometrical separation of the visible rays and X-rays.

### SUMMARY OF THE INVENTION

The technical objective of the present invention is to provide a small-sized X-ray image detector wherein the photoelectric sensor is protected against X-rays, but quality of the obtained images is high.

This objective is reached owing to the fact that the proposed X-ray image detector, as well as the known one, incorporates a light-tight housing with one wall transparent to X-rays, wherein a fluorescent screen, an optical system and a photoelectric matrix sensor are installed in series. But, what is different from the known apparatus design, in the proposed X-ray image detector the fluorescent screen is chosen such that it absorbs at least 30% of X-rays, and the optical system contains no less than 10 lenses having refraction index of no less than 1.6.

The obtained technical benefit is reduction of the X-ray image detector overall dimensions along with maintaining the ability to acquire high-quality image and keeping the photoelectric matrix sensor protected against X-rays.

This technical result is attained due to the fact that the fluorescent screen and the optical channel absorb X-rays.

The set of essential features recited in the claim 2 refers to the X-ray image detector wherein the fluorescent screen is based on cesium iodide.

The set of essential features recited in the claim 3 refers to the X-ray image detector wherein the fluorescent screen is based on gadolinium oxysulphide.

Both screens are used in the X-ray diagnostic apparatus, and their typical feature is the capability to absorb no less than 30% of X-radiation (for gadolinium oxysulphide activated by terbium—30%). The difference between them is that the screens based on cesium iodide demonstrate higher absorption and better resolution compared to the screens based on gadolinium oxysulphide, but they are much more expensive.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 represents a schematic of the X-ray image detector, and

FIG. 2 represents an embodiment of the detector optical system.

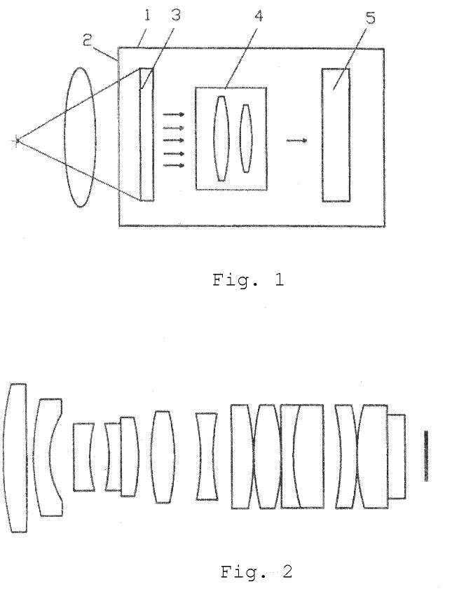

### DETAILED DESCRIPTION OF THE PREFERRED EMBODIMENTS

The X-ray image detector incorporates a housing 1 with one wall 2 transparent to X-rays, wherein there are a fluorescent screen 3, optical system 4 and a photoelectric matrix sensor 5, which can be, for instance, a CCD-matrix or a CMOS matrix sensor. The X-rays, having passed through the fluorescent screen based on, for example, gadolinium oxy-sulphide activated by terbium, becomes 30% weaker, and is transformed into the visible light. Further, the light flux passes through all the optical system components and reaches the photoelectric matrix sensor. However, not only the light flux gets into the optical system, but also the X-ray flux, which subsequently attenuates in the lens down to zero level.

When developing the X-ray image detector it was recognized that lenses having refraction index no less than 1.6 are made of glass doped with heavy metals, which can absorb X-rays. The conducted works have demonstrated that if the optical system incorporates 10 lenses made of glass having refraction index no less than 1.6 the intensity of X-ray that has passed through the fluorescent screen does not exceed the natural radiation background in the photoelectric matrix sensor surface.

Further works have proved the possibility of creating high-quality optical system provided that the condition mentioned above is followed. The developed schemes of the optical system are based on the principles put forth in the article “Synthesis of a fast wide-angle photographic objective lens with the increased back focal length” by Kozodoi V. V.: Priborostrojenije, State Committee of the RF for higher education, Bulletin of higher education establishments, vol. 37, February 1994, No 2, pp. 72-74.

FIG. 2 represents an embodiment of a wide-angle objective lens with large relative aperture containing 11 components, where the refraction index of the 12 lenses ranges between 1.7 and 1.8. This optical system meets all the requirements necessary for obtaining high-quality images in the CCD surface. Its focal distance is 21.7 mm, angular field is equal to 2ω, and relative aperture is 1:1.06. Loss of light flux intensity does not exceed 15%. Besides the X-ray image detector described in the example, the authors have developed four designs differing from one another in the fluorescent screens type and in the optical system design, which satisfied all the conditions disclosed in the claims. In all the X-ray image detectors the X-rays in the CCD surface did not exceed the normal background values. Only the optical characteristics were somewhat different, but all the optical systems were the wide-angle lenses with large relative aperture.

The design described above shows that it is possible to isolate the photoelectric matrix sensor from X-rays just by using a fluorescent screen and an optical system, employing neither additional protective screens, nor geometrical separation of the light rays and X-rays, providing thereby images of not inferior quality, what was proved by the 6-year practice with the fluorographic and radiographic (X-ray) apparatus based on the described design.

While this invention has been particularly shown and described with references to preferred embodiments thereof, it will be understood by those skilled in the art that various changes in form and details may be made therein without departing from the scope of the invention encompassed by the appended claims.

What is claimed is:

1. An X-ray image detector comprising a housing with a radiotransparent wall, the housing comprising a fluorescent screen, an optical system and a photoelectric matrix sensor, wherein the fluorescent screen is chosen such that it absorbs at least 30% of X-rays, and the optical system comprises at least ten lenses having a refraction index of at least 1.6.

2. The X-ray image detector as claimed in claim 1, wherein the fluorescent screen is made of cesium iodide.

3. The X-ray image detector as claimed in claim 1, wherein the fluorescent screen is made of gadolinium oxy-sulphide.
